(19) United States
(12) Patent Application Publication
(10) Pub. No.: US 2026/0062822 A1
(43) Pub. Date: Mar. 5, 2026

(54) CATALYSTS WITH QUANTUM SENSORS AND CATALYSTS SYSTEM WITH THE SAME

(71) Applicant: Toyota Motor Engineering & Manufacturing North America, Inc., Plano, TX (US)

(72) Inventors: Shougo Higashi, Ann Arbor, MI (US); Songtao Wu, Ann Arbor, MI (US); Kevin V. Nielson, Bloomington, IN (US); Naveed Hussain, Ypsilanti, MI (US); Debasish Banerjee, Ann Arbor, MI (US)

(21) Appl. No.: 18/816,320

(22) Filed: Aug. 27, 2024

(51) Int. Cl. C25B 11/075; C25B 11/056; C25B 15/02; H01M 4/92

(52) U.S. Cl. CPC C25B 11/075; C25B 11/056; C25B 15/02; H01M 4/925

(57) ABSTRACT

A catalyst system includes a nanostructured textile catalyst and a 2D protective layer with room temperature spin defects disposed on the nanostructured textile catalyst and configured to monitor dissolution of the nanostructured textile catalyst. The 2D protective layer can be a 2D hexagonal boron nitride (hBN) layer with negatively charged boron vacancies. The catalyst system can also include a laser configured to illuminate the room temperature spin defects, a microwave source configured to irradiate the room temperature spin defects with microwaves, and a photoluminescent light detector configured to detect and measure photoluminescent light emitted from the room temperature spin defects such that dissolution of the nanostructured textile catalyst is monitored.

### TECHNICAL FIELD

The present disclosure generally relates to catalysts, and particularly to catalyst systems that monitor dissolution of the catalysts therein.

### BACKGROUND

The development of active, stable, and low-cost catalysts catalyst systems is an essential prerequisite for development of desired electrocatalytic devices such as fuel cells, water electrocatalysis cells, and carbon dioxide reduction electrocatalysis cells, among others.

The present disclosure addresses issues related to catalyst systems, and other issues related to catalysts.

### SUMMARY

In one form of the present disclosure, a catalyst system includes a nanostructured textile catalyst and a 2D protective layer with room temperature spin defects disposed on the nanostructured textile catalyst. The 2D protective layer is configured to monitor dissolution of the nanostructured textile catalyst.

In another form of the present disclosure, a catalyst system includes a nanostructured textile catalyst and a 2D hBN protective layer with room temperature spin defects disposed on the nanostructured textile catalyst. The 2D hBN protective layer is configured to monitor dissolution of the nanostructured textile catalyst.

In still another form of the present disclosure, a catalyst system includes a nanostructured textile catalyst, a 2D hBN protective layer with room temperature spin defects disposed on the nanostructured textile catalyst, and a catalyst monitoring system. The catalyst monitoring system includes a light source configured to propagate light onto the room temperature spin defects, a microwave source configured to propagate microwave radiation onto the room temperature spin defects, and a photoluminescent light detector configured to detect and measure photoluminescent light emitted from the room temperature spin defects such that the room temperature spin defects provide dissolution monitoring of the nanostructured textile catalyst.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 illustrates a polymer-electrolyte membrane (PEM) water electrolysis (PEMWE) cell with a catalyst and catalyst system according to the teachings of the present disclosure;

FIG. 2A is an exploded perspective view of a catalyst system according to the teachings of the present disclosure;

FIG. 2B is an assembled perspective view of the catalyst system in FIG. 2A;

FIG. 3 illustrates monitoring an environment with the catalyst system in FIGS. 2A-2B; and

FIG. 4 illustrates a PEM fuel cell with a catalyst and catalyst system according to the teachings of the present disclosure.

It should be noted that the figures set forth herein is intended to exemplify the general characteristics of the methods, algorithms, and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

The present disclosure provides catalysts and catalyst systems that provide for monitoring of the catalysts and/or monitoring an environment proximate to the catalyst. The catalysts are nanostructured textile catalysts with a 2D protective layer disposed thereon. The 2D protective layer includes room temperature spin defects that function as or provide room temperature quantum sensors. Stated different, the catalysts (also referred to herein as “catalyst system” or “catalyst systems”) according to the teachings of the present disclosure are layered structures with one layer being a nanostructured textile catalyst and another layer being a 2D protective layer that protects the nanostructured textile catalyst layer from fluid flowing into contact with the nanostructured textile catalyst layer and provides monitoring of the nanostructured textile catalyst and/or an environment proximate thereto.

In some variations, the 2D protective layer with the room temperature spin defects provides monitoring, directly and/or indirectly, of the dissolution or loss of catalytic material forming the nanostructured textile catalyst. In the alternative, or in addition to, the 2D protective layer with the room temperature spin defects provides monitoring, directly and/or indirectly, of chemical reactions being catalyzed by the nanostructured textile catalyst. As used herein, the phrase “monitoring directly” refers to monitoring or determining a property directly from a signal derived from the room temperature spin defects. An example of such a directly monitored property is the temperature of an environment in which the room temperature spin defects are disposed. Also, the phrase “monitoring indirectly” as used herein refers to monitoring or determining a property using or inferred from a directly monitored property as described above. An example of such an indirect monitored property is the rate of reaction of reactant molecules to reactant molecules that is based or inferred from the temperature of an environment in which the room temperature spin defects are disposed.

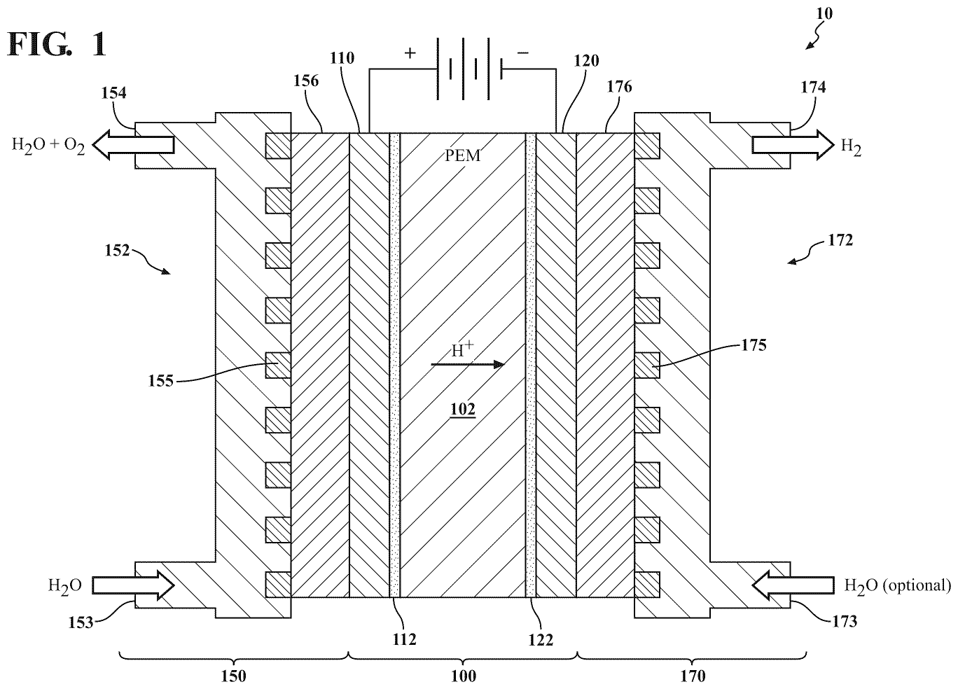

Referring now to FIG. 1, a polymer-electrolyte membrane (PEM) water electrolysis (PEMWE) cell 10 with a catalyst according to the teachings is shown. The PEMWE cell 10 includes a membrane electrode assembly (MEA) 100, an anode side fluid flow system 150, and a cathode side fluid flow system 170. The MEA 100 includes a PEM 102 sandwiched between an anode 110 with an anode catalyst layer 112 and a cathode 120 with a cathode catalyst layer 122.

The anode side fluid flow system 150 includes a bipolar plate 152 with an inlet 153, an outlet 154, and flow channels 155 in fluid communication with the inlet 153 and the outlet 154. The anode side fluid flow system 150 also includes a gas diffusion layer 156. The cathode side fluid flow system 170 includes a bipolar plate 172 with an inlet 173, an outlet 174, and flow channels 175 in fluid communication with the inlet 173 and the outlet 174. The cathode side fluid flow system 170 also includes a gas diffusion layer 176.

During operation of the PEMWE 10, water (H₂O) is provided to and flows through the inlet 153, the flow channels 155, the gas diffusion layer 156, and the anode 120such that the water comes into contact with the anode catalyst layer 112. The H₂O is oxidized at or by the anode catalyst layer 112 via an oxygen evolution reaction (OER) to oxygen (O₂), protons (H⁺) and electrons. In some variations, the O₂ is in the form of O₂ bubbles and the O₂ bubbles flow back through the gas diffusion layer 156 to the flow channels and exit the bipolar plate 152 with excess water via the outlet 154. The H⁺ ions flow through the PEM 102 to the cathode side fluid flow system 170 to undergo a hydrogen evolution reaction (HER) at the cathode 120 with the cathode catalyst layer 122 to form H gas, which flows through the gas diffusion layer 176, the flow channels 175, and the outlet 174. In some variations, water is provided through the inlet 173 as a carrier fluid for the H gas. In this manner, H₂ gas is formed or created from water.

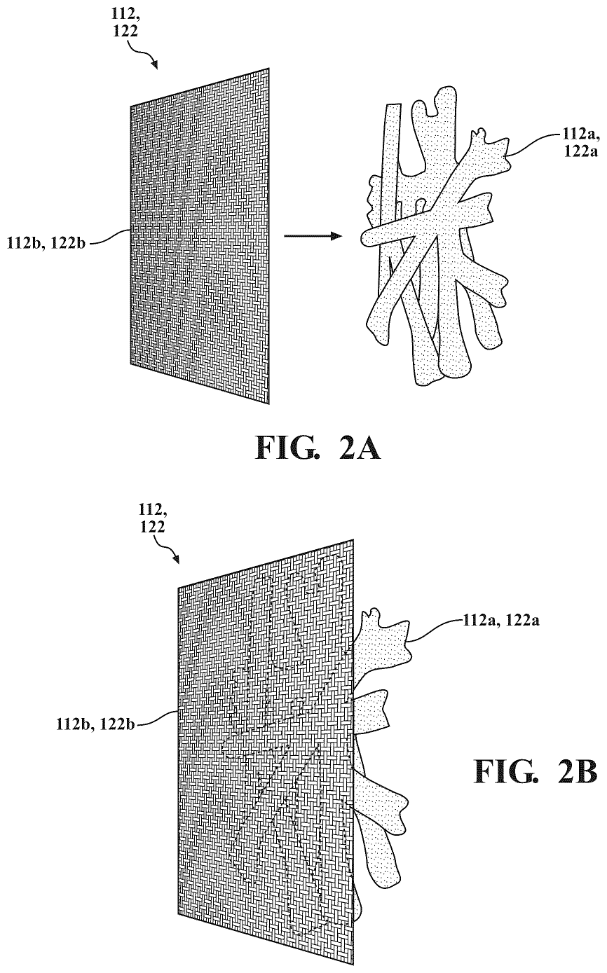

Referring to FIGS. 2A-2B, and exploded perspective view of a portion of the anode catalyst layer 112 and/or the cathode catalyst layer 122 (referred to herein as “catalyst layer 112, 122”) is shown in FIG. 2A and an assembled perspective view of a portion of the catalyst layer 112, 122 is shown in FIG. 2B. The catalyst layer 112, 122 includes a nanostructured textile catalyst 112a, 122a and a 2D protective layer 112b, 122b. And while FIGS. 2A-2B illustrate the 2D protective layer 112b, 122b covering the nanostructured textile catalyst 112a, 122a as a layer of foil would cover a bundle of fibers, in some variations individual fibers of the nanostructured textile catalyst 112a, 122a are covered or wrapped with the 2D protective layer 112b, 122b.

As used herein, the phrase “nanostructured textile catalyst” refers to layer of catalyst material formed by depositing a catalyst material (e.g., nanoparticles of a catalyst material) onto nanofibers to form a catalyst material shell on the nanofibers. In some variations, the nanofibers fibers are removed such that a catalyst skeleton or shell in the form of elongated hollow fiber shaped structures are formed. For example, in some variations the nanofibers are polymeric fibers formed from a water soluble polymer such as polyvinylpyrrolidone (PVP) and the polymer fibers are removed during operation of the PEMWE 10 when exposed to the flow of water. In addition, the nanostructured textile catalyst 112a, 122a can include any catalyst suitable for water electrolysis. For example, the catalyst material shell can be a transition metal such as iron and/or nickel, and/or a platinum group metal such as platinum, iridium, ruthenium, and/or osmium, and/or alloys or oxides thereof.

The 2D protective layer 112b, 122b covers the nanostructured textile catalyst 112a, 122a and thereby protects the catalyst material shells from damage and dissolution. For example, in some variations the 2D protective layer 112b, 122b covers and protects the fibers of the nanostructured textile catalyst 112a, 122a. In other variations, the 2D protective layer 112b, 122b provides a supporting structure for the nanostructured textile catalyst 112a, 122a such that the combined nanostructured textile catalyst 112a, 122a—2D protective layer 112b, 122b has enhanced mechanical strength compared to the nanostructured textile catalyst 112a, 122a without the 2D protective layer 112b, 122b. In other variations, the 2D protective layer 112b, 122b provides a barrier or shield for the nanostructured textile catalyst 112a, 122a such that damage to the nanostructured textile catalyst 112a, 122a caused by a fluid flowing into contact therewith is reduced. It should be understood that fluid (e.g., water) in the PEMWE 10 may or may not flow through the 2D protective layer 112b, 122b. In addition, the 2D protective layer 112b, 122b can be formed from materials such as graphene, phosphorene, hexagonal boron nitride (h-BN), borophene, germanene, silicene, titanate nanosheets, borocarbonitrides, MXenes, 2D silica, and transition-metal dichalcogenide such a molybdenum sulfide, among others.

As noted above, the 2D protective layer 112b, 122b includes or has room temperature spin defects that provide for monitoring the nanostructured textile catalyst 112a, 122a and/or monitoring an environment proximate to the nanostructured textile catalyst 112a, 122a. Non-limiting examples of the room temperature spin defects include negatively charged boron vacancies (V_{B}⁻) in h-BN and nitrogen vacancy (NV) centers in diamond nanoparticles. In some variations, the room temperature spin defects include a color center that is utilized to measure physical properties of an environment in contact with the protective layer 112b, 122b. The environment is, for example, water that has entered the cathode side fluid flow system 170 and reached the anode catalyst layer 112 and/or hydrogen ions at the cathode catalyst layer 122 of the PEMWE cell 10. As used herein, the phrase “color center” refers to a crystal defect which introduces or provides additional light absorption or light emission in crystalline materials. In some variations, the color center is an impurity, i.e., a foreign atom. In other variations, the color center is a vacancy.

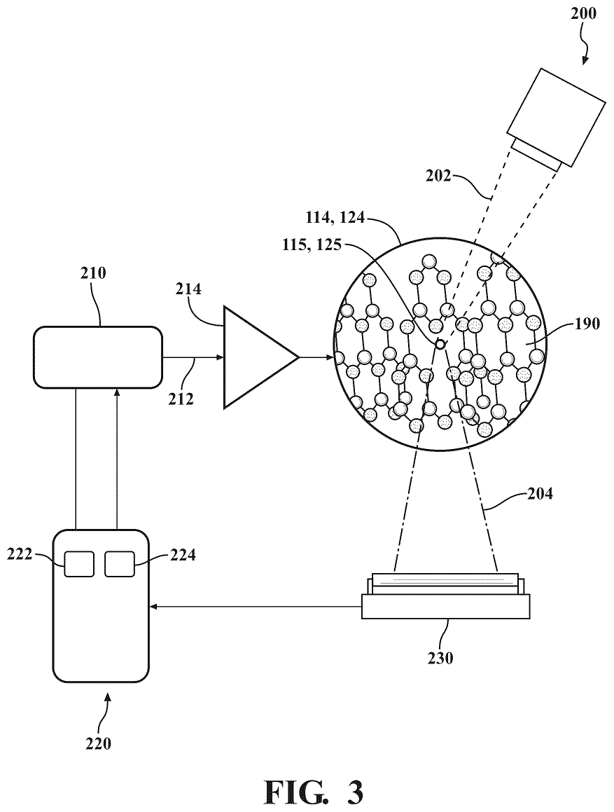

Referring now to FIG. 3, one example of using the 2D protective layer 112b, 122b as a monitoring device or part of a monitoring device is illustrated. Particularly, FIG. 3 illustrates a process of measuring a property of an environment 190 proximal to a room temperature spin defect 115, 125 that is within or part of a 2D protective layer 112b, 122b. A laser source 200 is used to emit a laser beam 202 that contacts or illuminates the room temperature spin defects 115, 125 that are direct contact with the environment 190. And the laser beam 202 excites the electrons of the room temperature spin defects 115, 125 which induces a fluorescence emission therefrom. The laser source 200 is, in one or more forms, a 532 nm green laser. In other forms, the laser source 200 emits longer laser wavelengths, e.g., 594 nm, 612 nm, 633 nm, 647 nm, 694 nm, among others. For example, the laser source 200 may be an indium gallium nitride (InGaN) based laser or InGaN LED light source that emits a 532 nm green laser or a Krypton (Kr) based laser that emits 647 nm red laser.

In addition to the laser source 200, a microwave source 210 is used to apply a microwave signal 212 to the room temperature spin defects 115, 125 during optically detected magnetic resonance (ODMR) spectroscopy. The microwave signal is, in one form, amplified by an amplifier 214. In any case, the applied microwave signal 212 causes changes in the spin state of the room temperature spin defects 115, 125 and induces resonance transitions. Resonance transitions may modulate the fluorescence (e.g., the wavelength and/or intensity of the fluorescence) emitted by the room temperature spin defects 115, 125. In one or more variations, a spectrometer 230 detects and analyzes the fluorescence emitted by the room temperature spin defects 115, 125. The fluorescence intensity and/or wavelength is measured by the spectrometer 230 as a function of the microwave signal emitted by the microwave source 210. The collected fluorescence data can be collected using a computer or microcontroller 220.

It should be understood that changes in fluorescence as a function of the microwave signal provide insights regarding the environment 190. For example, in one or more variations, the fluorescence intensity can provide information relating to strength of a magnetic field of or in the environment 190, an electric field of or in the environment 190, the pH of the environment 190, and/or the temperature of the environment 190. And by obtaining such information of or on the environment 190, time dependent properties of the anode catalyst layer 112 and/or the cathode catalyst layer 122. For example, obtaining such information as discussed above provides a dissolution rate of the nanostructured textile catalyst 112a, 122a, a reaction rate of product molecules to reactant molecules in the environment 190, among others. Accordingly, the catalyst layer 112, 122 provides for monitoring of the effectiveness and/or current operation of the PEMWE cell 10.

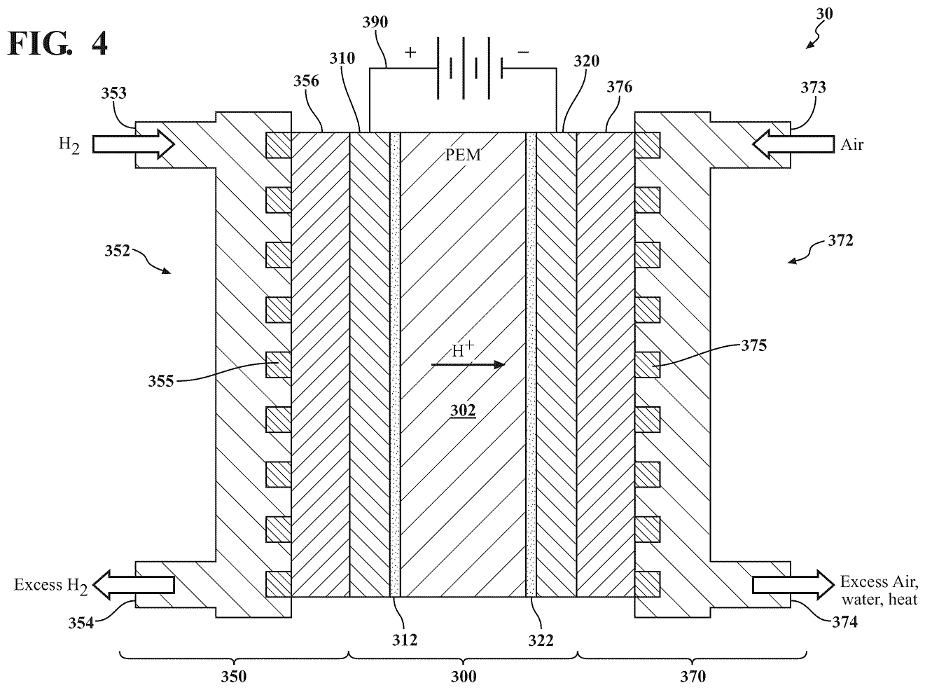

It should be understood that while FIGS. 1-3 are discussed in relation to a PEMWE, the catalyst layer 112, 122 can be used in other devices and/or systems. For example, and with reference to FIG. 4, a polymer-electrolyte membrane (PEM) fuel cell 30 with a catalyst according to the teachings is shown. The PEM fuel cell 30 includes a membrane electrode assembly (MEA) 300, an anode side fluid flow system 350, and a cathode side fluid flow system 330. The MEA 300 includes a PEM 302 sandwiched between an anode 310 with an anode catalyst layer 312 and a cathode 320 with a cathode catalyst layer 322. The anode catalyst layer 312 and/or the cathode catalyst layer 322 are similar or the same as the anode catalyst layer 112 and/or the cathode catalyst layer 122 described above. That is, the anode catalyst layer 312 includes a nanostructured textile catalyst (not shown) as described above with respect to the nanostructured textile catalyst 112a and a 2D protective layer (not shown) as described above with respect to the 2D protective layer 112b described above. In the alternative, or in addition to, the cathode catalyst layer 322 includes a nanostructured textile catalyst (not shown) as described above with respect to the nanostructured textile catalyst 122a and a 2D protective layer (not shown) as described above with respect to the 2D protective layer 122b described above.

The anode side fluid flow system 350 includes a bipolar plate 352 with an inlet 353, an outlet 354, and flow channels 355 in fluid communication with the inlet 353 and the outlet 354. The anode side fluid flow system 350 also includes a gas diffusion layer 356. The cathode side fluid flow system 370 includes a bipolar plate 372 with an inlet 373, an outlet 374, and flow channels 375 in fluid communication with the inlet 373 and the outlet 374. The cathode side fluid flow system 370 also includes a gas diffusion layer 376.

During operation of the PEM fuel cell 30, hydrogen (H₂) gas is provided to and flows through the inlet 353, the flow channels 355, the gas diffusion layer 356, and the anode 310, and comes into contact with the anode catalyst layer 312. Also, oxygen gas oxygen (O₂) (e.g., O₂ in air) is provided to and flows through the inlet 373, the flow channels 375, the gas diffusion layer 376, and the cathode 320, and into contact with the cathode catalyst layer 322. A portion of the H₂ is catalyzed into H⁺ ions and electrons (e⁻) via the anode catalyst layer 312 and a remaining portion (excess) of the H₂ exits the anode side fluid flow system 350 via the outlet 354. The H⁺ ions flow through the PEM 302 to the cathode catalyst layer 322, the electrons flow to the cathode 320 via an external electrical circuit 390 and react with the O₂ to form O²⁻ ions, and the O²⁻ ions react with the H⁺ ions to form water. The water, in addition to excess air and heat, is transported out of the cathode side fluid flow system 370 via the outlet 374. In this manner, electricity is generated or provided by the PEM fuel cell 30.

It should be understood that the anode catalyst layer 312 with the 2D protective layer (not shown) and/or the cathode catalyst layer 322 with the 2D protective layer (not shown) are used or function as a monitoring device or part of a monitoring device is illustrated as described above with respect to the anode catalyst layer 112 with the 2D protective layer 112b and/or the cathode catalyst layer 122 with the 2D protective layer 122b. Stated differently, the anode catalyst layer 312 with the 2D protective layer (not shown) and/or the cathode catalyst layer 322 with the 2D protective layer (not shown) can be used as part of a process of measuring a property of an environment proximal to a room temperature spin defects that are within or part of the 2D protective layers (not shown). And such a process can include illuminating the room temperature spin defects with a laser beam such that electrons of the room temperature spin defects are excited and induces a fluorescence emission therefrom. In addition, a microwave signal can be applied to the room temperature spin defects such that a change in spin state occurs, resonance transitions are induced, the fluorescence emission modulates, and a spectrometer 230 detects and analyzes the fluorescence emitted by the room temperature spin defects as a function of the microwave signal.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should also be understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A catalyst system comprising:
a nanostructured textile catalyst; and
a 2D protective layer with room temperature spin defects disposed on the nanostructured textile catalyst, the 2D protective layer configured to reduce and monitor dissolution of the nanostructured textile catalyst.

2. The catalyst system according to claim 1, wherein the nanostructured textile catalyst comprises nanofibers and catalyst nanoparticles disposed thereon.

3. The catalyst system according to claim 2, wherein the nanofibers are polymeric nanofibers.

4. The catalyst system according to claim 3, wherein the polymeric nanofibers are water soluble nanofibers.

5. The catalyst system according to claim 1, wherein the nanostructured textile catalyst comprises catalyst nanoparticles selected from the group consisting of noble-metal nanoparticles, noble-metal oxide nanoparticles, nickel-containing nanoparticles, iron-containing nanoparticles, graphene nanoparticles, silver-containing nanoparticles, gold-containing nanoparticles, copper-containing nanoparticles, and combinations thereof.

6. The catalyst system according to claim 5, wherein the catalyst nanoparticles comprise iridium oxide nanoparticles.

7. The catalyst system according to claim 1, wherein the 2D protective layer is selected from the group consisting of 2D graphene protective layers, 2D hBN protective layers, 2D transition metal dichalcogenide protective layers, 2D phosphorene protective layers, and 2D Xene protective layers.

8. The catalyst system according to claim 7, wherein the 2D protective layer comprises a 2D hBN protective layer.

9. The catalyst system according to claim 7, wherein the room temperature spin defects are negatively charged boron vacancies.

10. The catalyst system according to claim 1 further comprising a catalyst monitoring system comprising a light source configured to propagate light onto the room temperature spin defects, a microwave source configured to propagate microwave radiation onto the room temperature spin defects, and a photoluminescent light detector configured to detect and measure photoluminescent light emitted from the room temperature spin defects.

11. A catalyst system comprising:
a nanostructured textile catalyst; and
a 2D hBN protective layer with room temperature spin defects disposed on the nanostructured textile catalyst, the 2D hBN protective layer configured to reduce and monitor dissolution of the nanostructured textile catalyst.

12. The catalyst system according to claim 11, wherein the nanostructured textile catalyst comprises polymeric nanofibers with catalyst nanoparticles disposed thereon.

13. The catalyst system according to claim 12, wherein the polymeric nanofibers are water soluble nanofibers.

14. The catalyst system according to claim 12, wherein the catalyst nanoparticles are selected from the group consisting of noble-metal nanoparticles, noble-metal oxide nanoparticles, nickel-containing nanoparticles, iron-containing nanoparticles, graphene nanoparticles, silver-containing nanoparticles, gold-containing nanoparticles, copper-containing nanoparticles, and combinations thereof.

15. The catalyst system according to claim 14, wherein the catalyst nanoparticles comprise iridium oxide nanoparticles.

16. The catalyst system according to claim 15, wherein the room temperature spin defects are negatively charged boron vacancies.

17. The catalyst system according to claim 11 further comprising a catalyst monitoring system comprising a light source configured to propagate light onto the room temperature spin defects, a microwave source configured to propagate microwave radiation onto the room temperature spin defects, and a photoluminescent light detector configured to detect and measure photoluminescent light emitted from the room temperature spin defects.

18. A catalyst system comprising:
a nanostructured textile catalyst;
a 2D hBN protective layer with room temperature spin defects disposed on the nanostructured textile catalyst, the 2D hBN protective layer configured to reduce and monitor dissolution of the nanostructured textile catalyst; and
a catalyst monitoring system comprising:
a light source configured to propagate light onto the room temperature spin defects;
a microwave source configured to propagate microwave radiation onto the room temperature spin defects; and
a photoluminescent light detector configured to detect and measure photoluminescent light emitted from the room temperature spin defects.

19. The catalyst system according to claim 18, wherein the nanostructured textile catalyst comprises catalyst nanoparticles selected from the group consisting of noble-metal nanoparticles, noble-metal oxide nanoparticles, nickel-containing nanoparticles, iron-containing nanoparticles, graphene nanoparticles, silver-containing nanoparticles, gold-containing nanoparticles, copper-containing nanoparticles, and combinations thereof.

20. The catalyst system according to claim 19, wherein the catalyst nanoparticles comprise iridium oxide nanoparticles and the room temperature spin defects are negatively charged boron vacancies.
